(19) United States
(12) Patent Application Publication
(10) Pub. No.: US 2005/0227767 A1
(43) Pub. Date: Oct. 13, 2005

(54) Data management method using communication network and data management device

(75) Inventors: Satoshi Shimomura, Tokyo (JP); Yuko Tamada, Tokyo (JP); Hiromasa Kaneko, Tokyo (JP)

Correspondence Address: DARBY & DARBY P.C., P. O. BOX 5257, NEW YORK, NY, 10150-5257, US

(73) Assignee: Konami Computer Entertainment Japan, Inc., Tokyo (JP)

(21) Appl. No.: 10/851,594

(22) Filed: May 21, 2004

(30) Foreign Application Priority Data
Apr. 9, 2004 (JP) 2004-115483

(51) Int. Cl. G06F 19/00; G06F 17/00

(52) U.S. Cl. 463/42

(57) ABSTRACT

A unique ID 35 by which a distribution region can be identified is attached to a use-permission certificate 33 distributed in different regions. Different terminal devices send unique terminal device IDs to a data management device. Based on these IDs, the region in which the terminal device is installed is determined. IDs attached to use-permission certificates are sent by the terminal devices to the data management device through a communication network. Based on these IDs, the distribution regions of the use-permission certificates are determined. If the determined terminal device installation region and the use-permission certificate distribution region match, the use of data by the terminal device is allowed.

### INCORPORATION BY REFERENCE

The present application claims priority under 35 U.S.C. §119 to Japanese Patent Application No. 2004-115483 filed on Apr. 9, 2004. The content of the application is incorporated herein by reference in its entirety.

### BACKGROUND OF THE INVENTION

The present invention relates to a data management method and device for the same suitable for allowing the use of data, e.g., downloading music or video data or playing games between a terminal device and a server by way of the Internet or communication lines such as telephone lines, using a usage certificate, e.g., a proof-of-purchase certificate on which there is a barcode or a game card distributed in multiple regions around the globe, and a terminal device, e.g., a game execution terminal such as a portable telephone, a personal computer, or a home game machine.

A system in which a fee is paid using a credit card to connect a game execution terminal to a server via a communication line and a game is played for a predetermined time based on the fee has been widely known.

The applicant is not aware of a systematically described game execution system of this type that should be disclosed as background technology.

In recent years, there has been proposed an online game in which game cards, e.g., pre-paid cards, are widely distributed to players for a fee. Players can play a game by operating a game terminal connected to a server via a communication line. The number of points recorded on the game card corresponds to a game execution capacity (e.g., the number of events to be experienced by a player, the number of items to be obtained by the player, the number of time units to be played by the player, a numerical value indicating a number of experiences to be had by the player in a game). This game execution capacity is consumed as the player plays the game.

In this case, with the game card distributed in multiple regions world-wide, players in each region can operate the game terminals in their region and play the game, i.e., use game data, by accessing a server through communication lines such as the Internet.

In order to allow players around the world to enjoy the game while making the economic burden as fair as possible, there develops a need to have set different prices for different regions when distributing the game cards in order to take into account the economic conditions and price standards in the different regions in the world.

However, there is the possibility that a game card can be taken from a region in which the price is set low to a region in which the price is set high so that the game cards can be distributed to players in the regions with high prices, thereby disrupting the fairness among players in the different regions. Also, this can negatively affect the distribution of game cards in the different regions.

Also, these problems are not exclusive to games. They can apply to cases where music or video data is distributed at different prices to terminals around the world to allow users to use the disseminated data.

### SUMMARY OF THE INVENTION

The object of the present invention is to overcome the problems described above. The present invention provides a method for managing data and a device for the same that uses a communication network to restrict usage of use-permission certificates, e.g., game cards and purchase certificates with barcodes, distributed at different prices in multiple regions in the world, in regions other than the region in which they were distributed, thus maintaining the fairness of the economic burden imposed on users and players in different regions and also allowing appropriate activity to be performed for distribution of the use-permission certificates in different regions.

In a server (10) connected by way of a communication network (2) to a plurality of game execution terminals (9) installed in a plurality of regions (ARA1, ARA2, ARA3 . . . ARAn) world-wide, an implementation of the invention provides:
a data management method including:
a step for associating unique passwords to game cards distributed in the regions, the passwords allowing identification of regions in which the game cards are distributed, and the server determining an installation region of the game execution terminal based on a global address of the game execution terminal sent to the server from the game execution terminal via the communication network;
a step for the server determining a distribution region of the game card based on a password associated with the game card from the game execution terminal via the communication network; and
a step for the server giving permission to the game execution terminal to execute the game if the determined installation region of the game execution terminal matches the distribution region of the game card.

Another implementation of the invention is a data management method using a communication network further including: a step for the server to set up a player account containing player identification information of a player;
a step for keeping a sum of the player accounts for each global address and determining whether or not at least a predetermined number of the player accounts is set up for a single global address; and
a step for outputting a message to outputting means (25) if it is determined that the predetermined number or more of the player accounts is set up for a single global address.

In a data management device (10) connected via a communication network (2) to a plurality of terminal devices (9) assigned unique first IDs (=identifiers, e.g., GARs), still another implementation of the invention provides a data management method including:
a step for assigning unique second IDs (=identifiers, e.g., passwords 35) to usage certificates (33) distributed in a plurality of regions around the world, the second ID allowing identification of a region in which the usage certificate is distributed;
a step for the data management device using the first ID sent to the data management device via the communication network from the terminal device to identify an installation region (ARA1, ARA2, . . . ) of the terminal device assigned the first ID;
a step for the data management device using the second ID assigned to the usage certificate sent to the data management device via the communication network from the terminal device to identify a distribution region (ARA1, ARA2, . . . ) of the usage certificate; and
a step for the data management device giving permission to the terminal device to use a predetermined program or data if the determined installation region of the terminal device matches the distribution region of the permission certificate;
wherein permission is given to use the predetermined program or data only in a predetermined region in which the usage certificate is distributed.

In a data management device connected via a communication network to a plurality of game execution terminals installed in a plurality of regions around the world, a data management device (10) comprising:
means for determining installation position (15, 19) determining an installation region of the game execution terminal based on a global address of the game execution terminal sent from the game execution terminal via the communication network to the data management device;
means for determining distribution region (16, 20) determining a distribution region of a game card based on a password assigned to the game card sent from the game execution terminal via the communication network to the data management device; and
means for giving game execution permission (21) giving the game execution terminal permission to execute the game if the determined installation region of the game execution terminal matches the distribution region of the game card;
wherein permission is given to execute the game only for a game card distributed in the predetermined region.

Another implementation of the invention is a data management device including: player account setup means (17, 28) setting up a player account storing player identification information of a player;
player account summation means (21) keeping a summation for each global address of the player accounts and determining whether or not at least a predetermined number of the player accounts is set up for a single global address; and
means for outputting a message to output means (25) if there is a determination that at least a predetermined number of the player accounts is set up for a single global address.

In a data management device connected via a communication network to a plurality of terminal devices assigned unique first IDs, another implementation of the invention provides a data management device comprising:
means for determining installation position determining an installation region of the terminal devices based on the first ID of the terminal device sent to the data management device by way of the communication network;
means for determining distribution region determining a distribution region of a usage certificate based on a second ID assigned to the usage certificate sent from the terminal device via the communication network to the data management device; and
means for giving usage permission for predetermined program or data to the terminal device if the determined installation region for the terminal device matches the distribution region of the usage certificate;
wherein permission to use the predetermined program or data is given only to a predetermined region in which the usage certificate was distributed.

According to the implementations of the inventions, permission to execute the game at the game execution terminal is not granted unless the game execution terminal installation region matches the game card distribution region. This makes it possible to effectively restrict the use of game cards distributed at different prices in multiple regions around the world from being used in regions other than their distribution regions, thus maintaining fairness of economic burdens taken on by players in different regions and allowing appropriate game card distribution activity to take place in the different regions.

Also, by having the server evaluate matches between the game execution terminal installation region and the game card distribution region, the chance of improper activity is greatly reduced compared to performing evaluations on the game execution terminal side. As a result, system reliability is improved.

According to the implementations of the inventions, the setting up of multiple player accounts from a single global address can be detected, making it possible to easily discover improper accesses where game execution terminals and proxy servers installed across regions are improperly used. This contributes to maintaining fairness between players in different regions.

According to the implementations of the invention, permission to use the predetermined game or data at the terminal device is not granted unless the terminal device installation region matches the usage certificate distribution region. This makes it possible to effectively restrict the use of usage certificates distributed at different prices in multiple regions around the world from being used in regions other than their distribution regions, thus maintaining fairness of economic burdens taken on by users or players in different regions and allowing appropriate usage certificate distribution activity to take place in the different regions.

By having the evaluation of whether the installation region of the terminal device matches the distribution region of the usage certificate take place at the data management device, the chance of improper activity is greatly reduced compared to performing evaluations on the game execution terminal side. As a result, system reliability is improved.

The numerals inside the parentheses are to facilitate indicating corresponding elements in the figures. This description is therefore not restricted or limited by what is shown in the figures.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a simplified drawing showing a network in which an example of a game card management method according to the present invention is implemented.

FIG. 2 is a drawing showing an example of a game execution terminal.

FIG. 3 is a flowchart showing an example of a game card management procedure.

### DETAILED DESCRIPTION OF THE PREFERRED EMBODIMENTS

The embodiments of the present invention will be described below, with references to the figures.

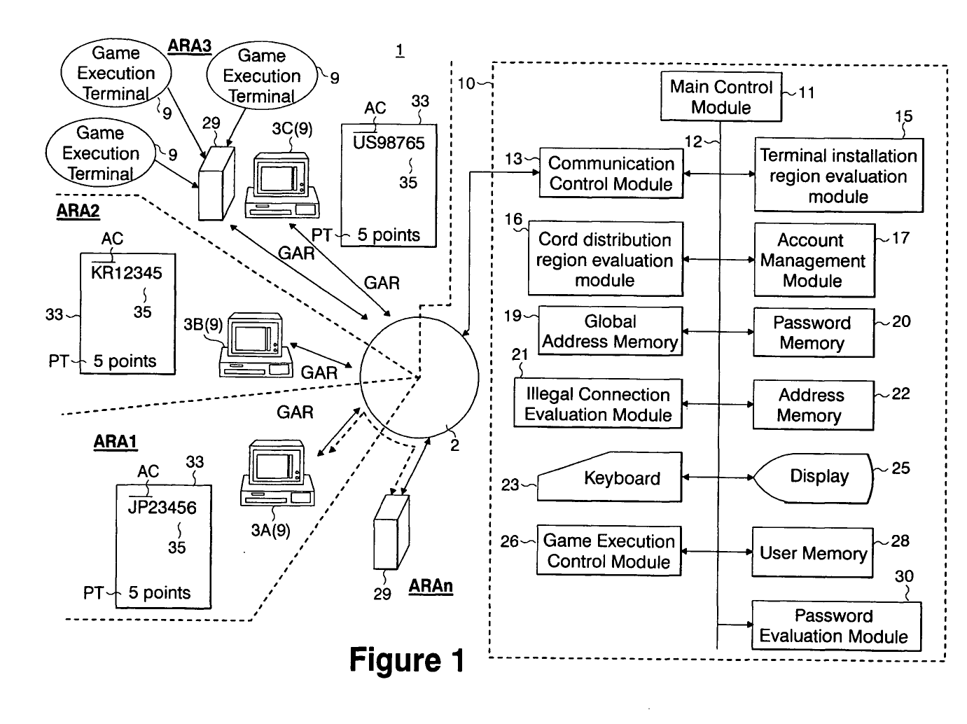

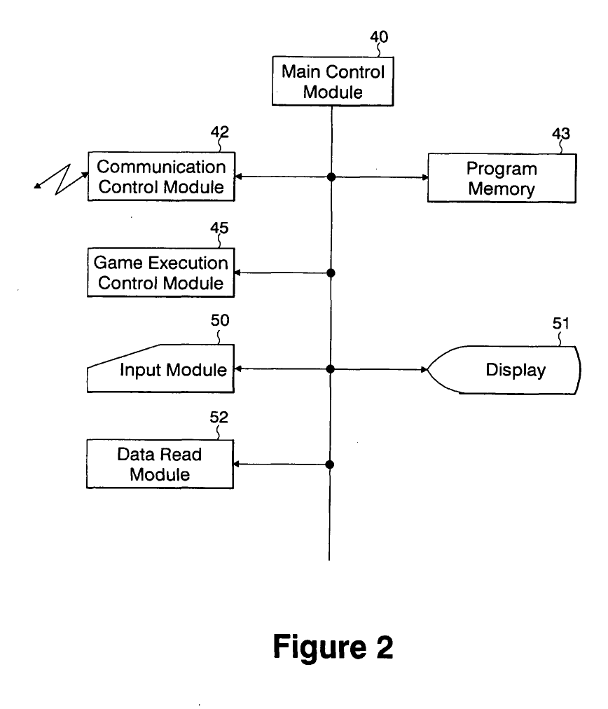

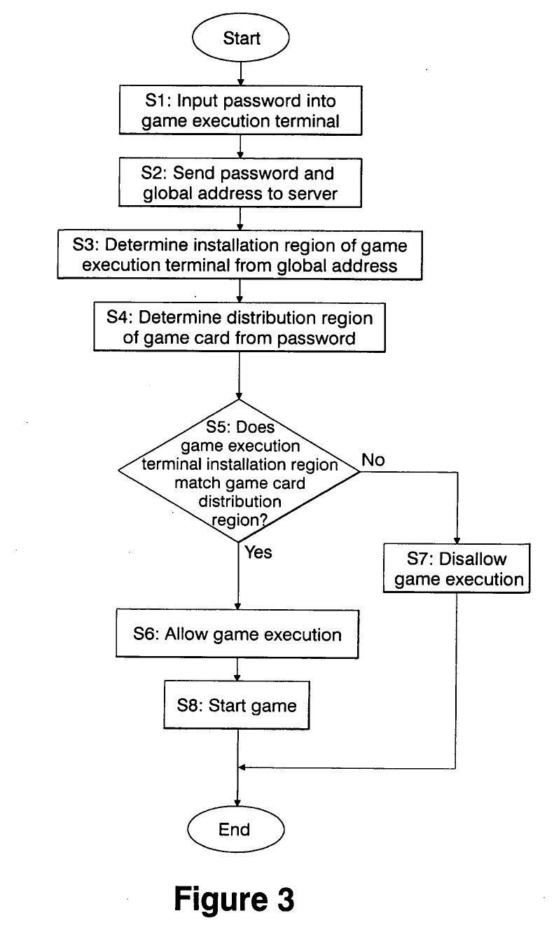

FIG. 1 is a simplified drawing showing a network implementing one example of a game card management method according to the present invention. FIG. 2 is a drawing showing an example of a game execution terminal. FIG. 3 is a flowchart showing an example of a game card management procedure.

As shown in FIG. 1, a network 1 includes a communication network 2, e.g., a telephone line or the Internet. In the communication network 2, multiple personal computers 3A, 3B, 3C are connected to serve as game execution terminals 9. Besides the personal computers 3, the game execution terminals 9 connected to the communication network 2 can include other devices as long as they can execute games, e.g., portable telephones and game machines.

Multiple communication devices 29, e.g., proxy servers, that can connect to multiple game execution terminals 9 are connected to the communication network 2. Furthermore, as indicated by the dotted lines, the communication network 2 is set up to span multiple countries and regions, e.g., regions ARA1, ARA2, ARA3, . . . ARAn. As a result, game execution terminals 9 in different countries and regions can connect to the communication network 2 in order to access a server 10, described later.

In the communication network 2, there is relaying means, e.g., an Internet service provider, for each region ARA1, ARA2, ARA3, . . . , ARAn. These relaying means are assigned unique codes (e.g., country codes) indicating the corresponding region ARA1, ARA2, ARA3, . . . ARAn. The game execution terminals 9 in these regions described above are connected to these relaying means by way of the communication network 2 and are also connected to the server 10 described above solely by way of these relaying means.

The server 10 is connected to the communication network 2. The server 10 includes a main control module 11 and, connected to the main control module 11 by way of a bus 12, a communication control module 13, a terminal installation region evaluation module 15, a card distribution region evaluation module 16, an account management module 17, a global address memory 19, a password memory 20, an illegal connection evaluation module 21, an address memory 22, a keyboard 23, a display 25, a game execution control module 26, and a user memory 28.

Also, as shown in FIG. 2 the game execution terminal 9 includes a main control module 40 and, connected to the main control module 40 by way of a bus 41, a communication control module 42, a program memory 43, a game execution control module 45, an input module 50, a display 51, and a data read module 52.

The blocks in the game execution terminals 9 and the server 10 are schematic illustrations of software-based functions performed by computers and do not indicate actual hardware units in the devices.

In the network 1 having the structure described above, a player living in a region ARA1, ARA2, ARA3, . . . ARAn must pay a predetermined amount of money to purchase a game card 33, i.e., a usage certificate, from a store in town in order to play the game. The game card 33 is assumed to be widely distributed via the marketplace by the game administrator as an item needed to play a predetermined game with the game execution terminal 9, thus allowing the player to freely purchase the game card 33 by paying a predetermined amount.

The distribution prices of the game card 33 in the regions ARA1, ARA2, ARA3, . . . ARAn are, for the uniform points PT (game execution capacity) described later, set differently according to region, taking into account the economic conditions and price levels of the particular region. Thus, while players in the different regions world-wide pay different amounts for the same type of game card, the distribution prices are set up so that the economic burdens are as fair as possible between the different regions.

The game card 33 contains a password 35 unique to that particular game card 33 (i.e., there is a one-to-one correspondence between each game card 33 on the market and a password 35). The password 35 is formed as a string of multiple digits and letters. The alphabetical section of the first two places in the password 35 (e.g., a section indicating “US”, “KR”, “JP”, or the like) serves as a region code AC representing the region ARA1, ARA2, ARA3, . . . ARAn in which the particular game card 33 is distributed. Thus, the player is able to look at the region code AC at the start of the password 35 to determine the region ARA1, ARA2, ARA3, . . . ARAn in which the password 35 was distributed.

The game card 33 also shows the game execution capacity for the game card 33 in the form of the points PT. In the game card 33 shown in FIG. 3, the points PT are shown as a fixed numerical quantity, e.g., 5 points.

After purchasing the game card 33, the player in the region ARA1, ARA2, ARA3 . . . ARAn runs the game software by using the game execution terminal 9 and loading the game software stored in a recording medium, e.g., a ROM disk, into the program memory 43 via the data read module 52. As shown in FIG. 2, the game execution terminal 9 uses a display 51 to ask, based on a game program GPR stored in the program memory 43, the player to enter the password 35.

In response, the player uses the input module 50 to enter the password 35 shown on the game card 33, as indicated in step S1 in FIG. 3. Next, the main control module 40 of the game execution terminal 9 accesses the server 10 by way of the communication network 2 and connects the game execution terminal 9 to the server 10. The communication via the communication control module 42 with the server 10 is also performed based on control from the game program GPR.

Besides manual entry using the input module 50, other methods are possible for entering the password 35, e.g., entry using a reading device not shown in the figure equipped in the game execution terminal 9 to rear storing means embedded in the game card 33, e.g., an IC chip, a magnetic stripe, or a barcode.

As shown in FIG. 1, the main control module 40 of the game execution terminal 9 sends to the server 10 via the communication network 2 the entered password 35 from the game card 33 along with a global address GAR, e.g., an IP address assigned by relaying means to each game machine terminal 9 in the regions ARA1, ARA2, ARA3 . . . ARAn (step S2 in FIG. 3). The main control module 11 of the server 10 uses the communication control module 13 to receive the password 35 from the game execution terminals 9 in the regions ARA1, ARA2, ARA3 . . . ARAn and the global address GAR of each game execution terminal 9, and these are sent to the password evaluation module 30 and the terminal installation region evaluation module 15.

If the communication network 2 is the Internet and the game execution terminals 9 are connected to the communication network 2 via a relay device, e.g., a router, and the global address GAR assigned to the relay device is used to connect the game execution terminal 9 to the server 10 via the communication network 2, the game global address GAR of the game execution terminal 9 is the global address GAR assigned to the relay device.

Instead of having the global address GAR sent independently to the server 10 from the game execution terminal 9, it would also be possible to have the global address obtained indirectly from the sender addresses in the various data packets sent to the server 10 when the game execution terminal 9 accesses the server 10.

The password evaluation module 30 evaluates the formal validity of the password 35, e.g., the length and format. If the password 35 is found to be valid, the operations performed by the card distribution region evaluation module 16 are begun. If the password is found to be invalid, the game execution terminal 9 sending the password is notified, and the player is requested to enter the correct password 35.

In the game execution terminal 9, the communication device connected to the communication network 2 is assigned a global address GAR serving as a unique identifier for connecting to the communication network 2 by relaying means, e.g., an Internet provider. This global address GAR includes within it a code assigned by relaying means described above to identify the region ARA1, ARA2, ARA3 . . . ARAn where the game execution terminal 9 is located. The terminal installation region evaluation module 15 refers to the global address GAR sent from the game execution terminal 9 in the region ARA1, ARA2, ARA3 . . . ARAn and a global address assignment table, organized by regions, stored in the global address memory 19. Based on this, the region ARA1, ARA2, ARA3 . . . ARAn of the game execution terminal 9 assigned the global address GAR is determined (step S3 in FIG. 3).

More specifically, the global address memory 19 stores an address assignment table in which all the global addresses GAR that can be assigned to communication devices connected to the communication network 2 are organized according to their regions ARA1, ARA2, ARA3 . . . ARAn. Each global address GAR sent from a game execution terminal 9 is looked up in the address assignment table to immediately determine which of the regions ARA1, ARA2, ARA3 . . . ARAn the game execution terminal 9 is located in.

When the region ARA1, ARA2, ARA3 . . . ARAn of the game execution terminal 9 is determined from the global address GAR sent to the server 10 by the game execution terminal 9, the main control module 11 uses the password 35 sent along with the global address GAR from the game execution terminal 9 to look up the table of passwords organized by region stored in the password memory 20 to determine the region ARA1, ARA2, ARA3 . . . ARAn in which the game card 33 with the password 33 was distributed (step S4 in FIG. 3).

More specifically, the password memory 20 contains a password table in which are entered, for the passwords 35 associated with all the game cards 33 distributed in the regions around the world, data relating to the distribution region, this data being stored as attribute data for the passwords 35. The passwords 35 of the game card 33 sent from the game execution terminal 9 is looked up in the password table so that the specific region ARA1, ARA2, ARA3 . . . ARAn in which the game card 33 was distributed can be determined immediately. The distribution region data in the password table is stored so that it can be associated with all the characters, including the region code AC, of the password 35 of the game card 33, thus allowing the distribution region to be determined based on an accurate identification of the game card 33.

Once the installation region of the game execution terminal 9 and the distribution region of the game card 33 have been determined from the global address GAR and the password 35 of the game card 33 sent by the game execution terminal 9, the main control module 11 sends the evaluation results to the illegal connection evaluation module 21 to determine if the game card 33 is being used correctly in the region ARA1, ARA2, ARA3 . . . ARAn in which the game card 33 was distributed.

More specifically, the illegal connection evaluation module 21 evaluates whether the installation region ARA1, ARA2, ARA3 . . . ARAn determined from the game execution terminal 9 matches the distribution region ARA1, ARA2, ARA3 . . . ARAn of the game card 33 determined from the password 35 of the game card 33 sent from the game execution terminal 9 (step S5 in FIG. 3). If the installation region ARA1, ARA2, ARA3 . . . ARAn matches the distribution region ARA1, ARA2, ARA3 . . . ARAn, the game card 33 is assumed to be used properly in the region ARA1, ARA2, ARA3 . . . ARAn in which the game card 33 was distributed, and permission is given to the game execution control module 26 to execute the game, as described later (step S6 in FIG. 3).

If the installation region ARA1, ARA2, ARA3 . . . ARAn does not match the distribution region ARA1, ARA2, ARA3 . . . ARAn, it is assumed that the game card 33 is being used improperly in a region other than the region ARA1, ARA2, ARA3 . . . ARAn in which the game card 33 was distributed. Permission is then not granted the game execution control module 26 to execute the game (step S7 in FIG. 3). A notification that game execution is not permitted is sent by way of the communication control module 26 and the communication network 2 to the game execution terminal 9, and a warning message is issued to the player using the game execution terminal 9 to use a game card 33 that is valid in that region.

If permission is granted to execute the game, the main control module 11 of the server 10 instructs the account management module 17 to set up a player account containing player identification information associated with the password 35. In response, the account management module 17 sets up a player account associated with the password 35 in the user memory 28. An initial value of 5 points is set up in the player account as the game execution capacity, i.e., the points PT, for the password 35, and an instruction is sent by way of the communication network 2 to the corresponding game execution terminal 9 to register the player identification information. The password 35 for the game card 33 is formed so that there is a one-to-one correspondence with the points PT representing the game execution capacity. Thus, if the password 35 is known, the main control module 11 can use the password table stored in the password memory to easily determine the points PT provided by the game card 33. More specifically, in addition to the distribution region for the password 35, the password table stores, as attributes, various other information relating to the game card 33 such as the points PT associated with the password 35.

In response, at the game execution terminal 9, the player operates the input module 50 and enters player identification information INF, e.g., the player's name. The player identification information INF is sent to the server 10 by way of the communication network 2. The account management module 17 of the server 10 takes the received player identification information INF and stores it in the player account set up in the user memory 28 along with the points PT described above and the password 35.

When the account associated with the password 35 is set up, the main control module 11 of the server 10 gives game execution permission to the game execution terminal 9 associated with the password 35 for which the account management module 17 set up a new account. More specifically, permission is granted to use the game software stored in the program memory 43. When game execution permission is obtained, the game execution control module 45 of the game execution terminal 9 notifies the player via the display 51 that the game can be executed.

The player uses the input module 30 to issue an instruction to execute the game. The main control module 40 receives this and a predetermined game based on the game software is started by the game execution control module 45 based on the game software. For player vs. player on-line games, when the game is executed, the server 10 sends programs and data needed for the game, e.g., the operation information about the opponent, to the game execution terminal 9.

In this manner, the player operates the input module 50 of the game execution terminal 9, which serves as a computer, and plays the game according to the game scenario controlled by the game execution control module 45. In the game scenario, there are multiple events that consume the points PT, serving as accounting play zones. For example, a player vs. player card game is suited for this. In this case, the points PT are points paid out in the player vs. player card game. However, the present invention is not restricted to implementation for player vs. player card games, and can be implemented for various types of games such as role-playing games, action games, adventure games, sports games, and the like.

Also, when the player sets up a player account on the player server 10, it would be possible to have a play card that can be used for the card game, serving as a “present card”, sent from the server 10 to be downloaded by the game execution terminal 9 used by the player. This play card can be displayed in a virtual space formed in memory space of the RAM, not shown in the figures, of the game execution terminal 9, thus allowing the present card to be used as the player's own card for the player vs. player card game.

When the game execution control module 45 is about to execute an event that consumes the points PT, the player uses the input module 50 to instruct the game execution control module 45 whether or not to consume the points PT and execute the event. If the event is not to be executed, the progress of the game scenario stops at that point and the game execution control module 45 prevents the player from going further in the game.

If the player uses the input module 50 to issue an instruction to execute the event, the main control module 40 of the game execution terminal 9 accesses the server 10 by way of the communication control module 42 and the communication network 2, sends the password 35 of the game card 33 registered in the server 10, and issues a notification indicating that the points PT set up for the game card 33 will be consumed and the event will be executed.

The main control module 11 of the server 10 receives this and has the account management module 17 search the user memory 28 for the player account corresponding to the password 35 sent from the game execution terminal 9. Then the points PT stored in the player account is decremented by 1 point, e.g., the value “5” is updated to “4”, and the resulting points balance is notified. The game execution terminal 9 receives the notification and shows on the display 51 the points used by the player in this event as well as the balance of the points PT, “4”, which is the game execution capacity.

In this manner, the main control module 40 permits the game execution control module 45 to execute an event, and the event executed by the game execution control module 45 is played by the player using the input module 50.

What is executed according to the points PT, serving as the game execution capacity, set up for the game card 33 is not restricted to events set up in the game. Alternatively, the points PT can indicate predetermined game play time or the obtaining predetermined items. More specifically, the game that is executed by the game software in the game execution terminal 9 is separated into multiple accounting play zones set up based on events, play time, obtaining items, or the like (these accounting play zones do not necessarily need to be continuous with each other). By making payments with the points PT, individual accounting play zones can be purchased.

The communication network 2 can be connected directly to the game execution terminal 9 or, as shown in FIG. 1, can be connected to multiple game execution terminals 9 through the communication device 29, e.g., a proxy server, with the global address GAR being used only for the communication device 29. In these cases, the global address GAR for the communication device 29 is treated as the global address GAR of each game execution terminal 9. Based on this, the installation region ARA1, ARA2, ARA3, . . . ARAn of the communication device 29 is determined. By comparing this with the distribution region ARA1, ARA2, ARA3, . . . ARAn determined from the password 35 of the game card 33 received from the game execution terminal 9, an evaluation can be made of whether the game card 33 is being used in the appropriate distribution region of the game card 3.

But there may be cases, for example, where a game execution terminal 9 of the region ARA1 in FIG. 1 accesses, via the communication network 2, the server 10 using a communication device 29 located in another region ARAn. Thus, the game execution terminal 9 can have improper access to the game as if it were located in another region ARAn.

Therefore, the improper connection evaluation module 21 of the server 10 keeps a sum of the number of player accounts set up for the global address GAR in the address memory 22. If there is a predetermined number or more player accounts (e.g., 100 or more accounts) set up for a single global address GAR, improper access may be taking place (this is only a possibility, and in many cases the usage will be legitimate), and this global address GAR can be printed to outputting means such as a printer not shown in the figure or the display 25 along with the number of accounts that were set up.

In the embodiment described above, the usage certificate is the game card 33, and the program or data for which permission is granted by the server 10 serving as the data management device is game software. However, the usage certificate is not restricted to this and can be a form (it does not need to be a card and can be electronic data) that allows any type of program or data, e.g., music data, video data, or other programs. When permitting use of data, that use can be offered by allowing the terminal device such as the game execution terminal 9 to download the program or data for which permission is being granted from the data management device. Alternatively, instead of downloading the data, the data management device can send just a release instruction that releases a usage blocking state for the program or data that is set up in the terminal device ahead of time.

In the embodiment described above, if the distribution region and the connection region do not match, execution of the game is not allowed. However, the standards for game execution permission of the improper connection evaluation module 21 can take into account special factors for regions. For example, for regions having no price differences, a game card distributed in one region can be allowed to connect and execute games in another region. Also, game cards distributed in regions set up for a high price can be allowed for use in regions set up for a low price. In this way, game card distribution can be performed unhindered without decreasing the fairness between players. From the players' perspective, in fact, rare cards that are unavailable in the player's own region can be purchased in another region and can be used for accessing game execution, thus providing more convenience. Also, in the embodiment above, usage certificates are distributed at a price, but it would also be possible to distribute the usage certificates for free or to charge once an appropriate connection is confirmed. In this case, a price database is set up containing prices organized by region. Once a correct connection is confirmed by the illegal connection evaluation module 21, the price database is looked up for the determined region, the price for the region is retrieved, and the accounting data for each player can be stored by the account management module 17.

The present invention can be used when users or players use programs or data for a fee by connecting multiple terminal devices to the data management device via a communication network.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A data management method for a server connected through a communication network to a plurality of game execution terminals installed in a plurality of regions world-wide, comprising:
associating unique passwords to game cards distributed in said regions, said passwords allowing identification of regions in which said game cards are distributed, and said server determining an installation region of said game execution terminal based on a global address of said game execution terminal sent to said server from said game execution terminal through said communication network;
determining a distribution region of said game card based on a password associated with said game card from said game execution terminal through said communication network; and
giving permission to said game execution terminal to execute said game if said determined installation region of said game execution terminal matches said distribution region of said game card.

2. A data management method using a communication network as described in claim 1, further comprising:
setting up in the server a player account containing player identification information of a player;
keeping a sum of said player accounts for each global address and determining whether or not at least a predetermined number of said player accounts is set up for a single global address; and
outputting a message to outputting means if it is determined that said predetermined number or more of said player accounts is set up for a single global address.

3. A data management method for a data management device connected through a communication network to a plurality of terminal devices assigned unique first IDs, comprising:
assigning unique second IDs to usage certificates distributed in a plurality of regions around the world, said second ID allowing identification of a region in which said usage certificate is distributed;
identifying an installation region of said terminal device assigned said first ID for said data management device using said first ID sent to said data management device through said communication network from said terminal device;
identifying a distribution region of said usage certificate for said data management device using said second ID assigned to said usage certificate sent to said data management device through said communication network from said terminal device; and
giving permission from said data management device to said terminal device to use a predetermined program or data if said determined installation region of said terminal device matches said distribution region of said usage certificate;
wherein permission is given to use said predetermined program or data only in a predetermined region in which said usage certificate is distributed.

4. A data management device connected through a communication network to a plurality of game execution terminals installed in a plurality of regions around the world, comprising:
installation position determining means for determining an installation region of said game execution terminal based on a global address of said game execution terminal sent from said game execution terminal through said communication network to said data management device;
distribution region determining means for determining a distribution region of a game card based on a password assigned to said game card sent from said game execution terminal through said communication network to said data management device; and
game execution permission giving means for giving said game execution terminal permission to execute said game if said determined installation region of said game execution terminal matches said distribution region of said game card;
wherein permission is given to execute said game only for a game card distributed in said predetermined region.

5. A data management device as described in claim 4, comprising:
player account setup means for setting up a player account storing player identification information of a player;
player account summation means for keeping a summation for each global address of said player accounts and determining whether or not at least a predetermined number of said player accounts is set up for a single global address; and
means for outputting a message to output means if there is a determination that at least a predetermined number of said player accounts is set up for a single global address.

6. A data management device connected through a communication network to a plurality of terminal devices assigned unique first IDs, comprising:
installation position determining means for determining an installation region of said terminal devices based on said first ID of said terminal device sent to said data management device through said communication network;
distribution region determining means for determining a distribution region of a usage certificate based on a second ID assigned to said usage certificate sent from said terminal device through said communication network to said data management device; and
means for giving usage permission for predetermined program or data to said terminal device if said determined installation region for said terminal device matches said distribution region of said usage certificate;
wherein permission to use said predetermined program or data is given only to a predetermined region in which said usage certificate was distributed.
